(19) United States
(12) Patent Application Publication
(10) Pub. No.: US 2025/0229232 A1
(43) Pub. Date: Jul. 17, 2025

(54) METHODS FOR PREPARING FUNCTIONAL MEMBRANE FOR RECOVERING PRECIOUS METAL IONS FROM OILY WASTEWATER

(71) Applicants: SHAANXI WEIYI SCIENCE & TECHNOLOGY CO., LTD., Xi'an (CN); CHANG’AN UNIVERSITY, Xi'an (CN)

(72) Inventors: Mengting LI, Xi'an (CN); Xiaohan NIU, Xi'an (CN); Xi CHEN, Xi'an (CN); Min CHAO, Xi'an (CN); Luke YAN, Xi'an (CN)

(73) Assignees: SHAANXI WEIYI SCIENCE & TECHNOLOGY CO., LTD., Xi'an (CN); CHANG’AN UNIVERSITY, Xi'an (CN)

(21) Appl. No.: 19/008,607

(22) Filed: Jan. 2, 2025

(30) Foreign Application Priority Data
Jan. 11, 2024 (CN) 202410043483.7

(51) Int. Cl. B01D 67/00; B01D 71/02

(52) U.S. Cl. CPC B01D 67/0039; B01D 71/0211; B01D 71/05; B01D 2323/56

(57) ABSTRACT

A method for preparing a functional membrane for recovering precious metal ions from oily wastewater is provided. The method includes: obtaining carbon nanotubes functionalized by polyacrylic acid (CNTs-PAA) by grafting acrylic acid onto a surface of carbon nanotubes (CNTs) via graft polymerization; obtaining carbon nanotubes modified by acyl hydrazine functional groups (CNTs-PAH) by reacting adipic dihydrazide (ADH) with carboxyl functional groups of the CNTs-PAA; preparing single-layer MXene nanosheets using Ti₃AlC₂ powder; and preparing a CNTs-PAH/MXene composite membrane by vacuum filtration based on the CNTs-PAH and the single-layer Mxene nanosheets.

### CROSS-REFERENCE TO RELATED APPLICATIONS

This application claims priority to Chinese patent application No. 202410043483.7, filed on Jan. 11, 2024, the entire contents of which are hereby incorporated by reference.

### TECHNICAL FIELD

The present disclosure relates to the field of functional membrane materials, and in particular, to a method for preparing a functional membrane for recovering precious metal ions from oily wastewater.

### BACKGROUND

Carbon nanotubes possess a large specific surface area, a loose and porous network structure, and excellent mechanical properties, making them ideal materials for constructing separation membranes. Compared to other super-wetting membranes, their surface functionalization and porous network microstructure give them inherent advantages as functional membranes. Studies have demonstrated that the functional groups on the surface of carbon nanotubes are a crucial factor in enhancing their ability to recover precious metal ions. The surface of carbon nanotubes can be oxidized using strong oxidizing acids, hydrogen peroxide, or by grafting with certain polymers containing ligands for precious metal ions, which can modulate the physicochemical properties of carbon nanotubes and endow them with better recycling capabilities. However, most of the separation membranes reported thus far can only recover precious metals from a single aqueous solution. In actual wastewater, the pollutant compositions are often complex, resulting in unsatisfactory performance of carbon nanotube membranes in recovering precious metal ions from oily wastewater.

In view of the foregoing, it is desirable to provide a functional membrane for recovering precious metal ions from oily wastewater and a preparation method thereof to enhance the efficiency of carbon nanotube membranes in recovering precious metal ions from oily wastewater.

### SUMMARY

One or more embodiments of the present disclosure provide a method for preparing a functional membrane for recovering precious metal ions from oily wastewater, comprising: (a) obtaining carbon nanotubes functionalized by polyacrylic acid (CNTs-PAA) by grafting acrylic acid onto a surface of carbon nanotubes (CNTs) via graft polymerization; (b) obtaining carbon nanotubes modified by acyl hydrazine functional groups (CNTs-PAH) by reacting adipic dihydrazide with carboxyl functional groups of the CNTs-PAA; (c) preparing single-layer MXene nanosheets using Ti₃AlC₂ powder; and (d) preparing a CNTs-PAH/MXene composite membrane by vacuum filtration based on the CNTs-PAH and the MXene nanosheets.

One or more embodiments of the present disclosure provide a functional membrane made by a method of preparing a functional membrane for recovering precious metal ions from oily wastewater as described above.

### BRIEF DESCRIPTION OF THE DRAWINGS

The present disclosure will be further illustrated by way of exemplary embodiments, which will be described in detail through the accompanying drawings.

FIG. 1 is a flowchart illustrating an exemplary synthesis process according to some embodiments of the present disclosure;

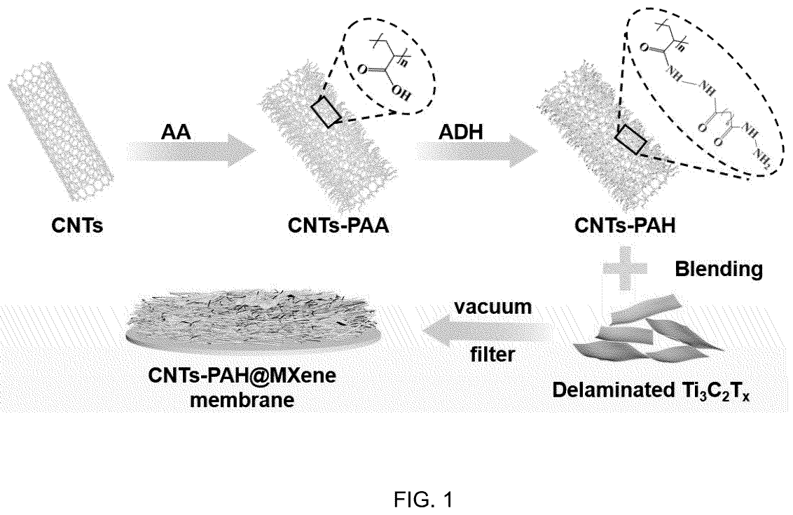

FIG. 2 is a block diagram illustrating contact angles of seven membranes against trichloromethane (chloroform) according to some embodiments of the present disclosure;

FIG. 3 is a block diagram illustrating an efficiency of recovering silver ions and an efficiency of oil-water separation of seven membranes in oil-water emulsions according to some embodiments of the present disclosure;

FIG. 4 is a block diagram illustrating a maximum recovery capacity of acyl hydrazine functional groups/Mxene20 (CNTs-PAH/Mxene-20) membranes for three precious metal ions according to some embodiments of the present disclosure;

FIG. 5 is a scanning electron microscope (SEM) photograph of a CNTs-PAH/Mxene-20 membrane after recovery of Ag (a), Au (b), and Pd (c) according to some embodiments of the present disclosure; and

FIG. 6 is a block diagram illustrating a catalytic efficiency of CNTs-PAH/Mxene-20 membranes for 4-nitrophenol (4-NP) after recovery of three precious metals according to some embodiments of the present disclosure.

### DETAILED DESCRIPTION

In order to provide a clearer understanding of the technical solutions of the embodiments described in the present disclosure, a brief introduction to the drawings required in the description of the embodiments is given below. It is evident that the drawings described below are merely some examples or embodiments of the present disclosure, and for those skilled in the art, the present disclosure may be applied to other similar situations without exercising creative labor, unless otherwise indicated or stated in the context, the same reference numerals in the drawings represent the same structures or operations.

Set forth in the present disclosure and the claims, unless explicitly indicated otherwise in the context, words such as “one,” “a,” “an,” and/or “the” do not specifically denote the singular form and may also include the plural form. In general, the terms “comprising” and “including” only suggest the inclusion of steps and elements that have been explicitly identified, and these steps and elements do not constitute an exclusive listing; methods may also include other steps or elements.

Unless otherwise defined, all technical and scientific terms used in the present disclosure have the same meaning as typically understood by those of ordinary skill in the art to which the present disclosure pertains.

One or more embodiments of the present disclosure provide a method for preparing a functional membrane for recovering precious metal ions from oily wastewater. The method includes the following operations.

(a) Carbon nanotubes functionalized by polyacrylic acid (CNTs-PAA) is obtained by grafting acrylic acid onto a surface of carbon nanotubes (CNTs) via graft polymerization.

The graft polymerization refers to a process in which monomers are covalently bonded and polymerized as side chains onto a main polymer chain (the backbone). Specifically, some techniques such as chemical or physical techniques may be used to create active centers on polymers. These active centers then initiate the graft polymerization of monomers onto the polymers. In some embodiments, the graft polymerization includes high energy radiation-induced graft polymerization, photoinitiated graft polymerization, and the like. High energy radiation-induced graft polymerization is to use high-energy rays (such as X-rays, γ-rays, α-rays, etc.) to generate free radical active centers on polymers and then initiate grafting. Photoinitiated grafting is to use ultraviolet light irradiation to initiate the graft polymerization of monomers to polymers.

In some embodiments, the obtaining the CNTs-PAA includes: dispersing the CNTs in acetone and performing ultrasonic treatment to obtain a CNTs dispersion; adding acrylic acid after vacuum distillation and recrystallized benzoyl peroxide (BPO) to the CNTs dispersion to obtain a mixture; and obtaining the CNTs-PAA by washing the mixture with deionized water and vacuum dry at 30° C.

(b) Carbon nanotubes modified by acyl hydrazine functional groups (CNTs-PAH) is obtained by reacting adipic dihydrazide with carboxyl functional groups of the CNTs-PAA.

Hydrazide compounds have a unique structure, and their chemical structure is generally represented as RC(O)—NH—NHR. In addition to having good biological activity, hydrazide compounds also have a strong coordination ability and is able to chelate with different metal ions to form complexes. Therefore, the strongly reducing acyl hydrazine group (R—CO—NHNH₂) is used to promote the adsorption of precious metals by enhancing the reduction of precious metals and form a large collectable precipitate.

In some embodiments, the step (b) includes: dispersing the CNTs-PAA in N,N-dimethylformamide (DMF), adding N,N′-carbonyldiimidazole (CDI) to obtain a mixed solution; adding the mixed solution to a DMF solution containing adipic dihydrazide (ADH) to obtain a mixture; and obtaining the CNTs-PAH by subjecting the mixture to filtration and vacuum dry at 30° C.

(c) Preparing single-layer MXene nanosheets using Ti₃AlC₂ powder.

In some embodiments, the step (c) includes: adding lithium fluoride to hydrochloric acid to prepare an etching solution; adding the Ti₃AlC₂ powder to the etching solution under an ice-water bath condition, transferring to an oil bath for stirring to obtain a product; centrifugally washing the product with deionized water, removing a precipitate by high-speed centrifugation to obtain a suspension, freeze-drying the suspension to obtain the MXene (Ti₃C₂TxMXene) nanosheets.

MXene nanosheets are atomic-thin two-dimensional materials. Their general formula can be expressed as Mₙ₊₁XₙTx. By using the weak binding force between the A layer and the MX layer in the MAX phase, a suitable etching solution (such as HF, LiFHCl, NH₄HF₂, etc.) is selected to etch the A atomic layer in the MAX phase to prepare it. MXene nanosheets have various properties such as metallic conductivity, hydrophilicity, high light transmission, biocompatibility, adjustable electronic structure, and high carrier mobility.

Ti₃C₂TxMXene is a kind of MXene, where Tx represents the functional groups attached to the surface of, which is produced by chemically etching the precursor MAX phase. In some embodiments, Tx is —OH, —F, —O or —Cl.

(d) Preparing a CNTs-PAH/MXene composite membrane by vacuum filtration based on the CNTs-PAH and the Mxene nanosheets.

In some embodiments, the step (d) includes: dispersing the CNTs-PAH in deionized water and performing ultrasonic treatment to obtain a CNTs-PAH dispersion; dispersing the MXene nanosheets in deionized water and performing ultrasonic treatment to obtain a MXene dispersion; and mixing the MXene dispersion and the CNTs-PAH dispersion to obtain a mixture, and filtering the mixture into a membrane after ultrasonic treatment.

In some embodiments, the mass ratio of the CNTs-PAH to the MXene nanosheets is 1:(0.1 to 0.5).

In some embodiments, the mass ratio of the CNTs-PAH to the MXene nanosheets is 1:0.2.

In some embodiments, the mass ratio of the CNTs-PAH to the MXene nanosheets is 1:0.4.

One or more embodiments of the present disclosure provide a functional membrane for recovering precious metal ions from oily wastewater, which is prepared as described above.

One or more embodiments of the present disclosure also provide a use of a functional membrane as described above in recovering metal ions as well as in catalyzing organic pollutants.

The embodiments of the present disclosure have at least the following beneficial effects. (1) Acyl hydrazine functional groups (R—CO—NHNH₂) are grafted on the surface of carbon nanotubes, and the acyl hydrazine functional groups have a rapid and selective reduction ability for precious metal ions in aqueous solutions. (2) Two-dimensional Ti₃C₂TxMXene nanosheets are introduced to solve the problem of inefficient oil-water separation. MXene nanosheets have a hydrophilic surface, large surface area, high electrical conductivity, abundant surface functional groups, redox properties and high adsorption capacity, which have a wide range of applications in the field of water treatment. (3) MXene nanosheets are introduced into a carbon nanotube membrane system to optimize the surface wettability of the composite membrane, and to synergistically enhance the ability of the composite membrane to recover precious metals, thereby realizing the direct recovery of precious metal ions in the oil/water separation process.

The experimental techniques in the following examples, unless otherwise specified, are conventional techniques. The test materials used in the following examples, unless otherwise specified, are obtained from standard biochemical reagent companies. Quantitative assays in the following examples are performed with three replicate experiments, and the results are averaged.

### EXAMPLES

### Example 1

A method of preparing a functional membrane includes the following steps.

1) Firstly, carbon nanotubes functionalized by polyacrylic acid (CNTs-PAA) were prepared: 0.1 g CNTs were dispersed in 100 mL of acetone and sonicated for 20 min to obtain CNTs dispersion. Then 1.0 g of acrylic acid after vacuum distillation and 0.055 g of recrystallized benzoyl peroxide BPO were added to the CNTs dispersion and stirred at 75° C. for 8 h (the reaction was carried out under N₂ atmosphere). The resulting product was washed with deionized water and dried under vacuum at 30° C. to obtain the CNTs-PAA.

2) Subsequently, 0.1 g of the CNTs-PAA was uniformly dispersed into 50 mL of N,N-dimethylformamide (DMF). 1 g of N,N′-carbonyldiimidazole was dissolved into 10 mL of DMF, poured into the dispersion of CNTs-PAA and stirred for 12 h at room temperature to obtain a mixed solution. The resulting mixed solution was then added dropwise to adipic dihydrazide solution (10 g of adipic dihydrazide dissolved into 50 mL of DMF) and stirred for 24 h at 45° C. to obtain a mixture.

The resulting mixture was purified by washing and then dried under vacuum at 30° C. for 12 h to obtain nanotubes modified by acyl hydrazine functional groups (CNTs-PAH).

3) Then single-layer MXene nanosheets were prepared: 1.6 g of lithium fluoride (LiF) was added to 20 mL of hydrochloric acid (HCl) with a concentration of 9 mol/L to prepare an etching solution. 1.0 g of Ti₃AlC₂ powder was weighed and slowly added to the LiFHCl etching solution under an ice-water bath condition, and then transferred to a 45° C. oil bath and stirred for 36 h to obtain a product. The product obtained after the reaction was centrifugally washed with deionized water for several times and then centrifuged at high speed to remove a precipitate, and a suspension was freeze-dried to obtain single-layer MXene (Ti₃C₂TxMXene) nanosheets.

4) Finally, CNTs-PAH/MXene composite membranes were prepared by vacuum filtration: 20 mg of CNTs-PAH was dispersed in 200 mL of deionized water and ultrasonically treated for 30 min to obtain a CNTs-PAH dispersion. Then 10 mg of MXene was dispersed in 200 mL of deionized water and ultrasonically treated for 1 hour to obtain a MXene dispersion. Then different volumes (5, 10, 15 and 25 mL) of the MXene dispersion were respectively mixed with 25 mL of the CNTs-PAH dispersion, and after ultrasonic treatment for 10 min, filtration was carried out to form a membrane.

The prepared composite membranes were sequentially named CNTs-PAH/MXene-10, CNTs-PAH/MXene-20, CNTs-PAH/MXene-30, and CNTs-PAH/MXene-50.

### Comparative Example 1

Comparative Example 1 of the present disclosure provides a method of preparing a CNTs membrane.

1) 10 mg of CNTs powder was dispersed in a mixture of 50 mL of deionized water and 50 mL of ethanol, and ultrasonically treated for 1 h to obtain dispersion A.

2) 30 mL of the dispersion A was taken and a CNTs membrane was obtained by vacuum filtration.

### Comparative Example 2

Comparative Example 2 of the present disclosure provides a method for preparing a CNTs-PAH membrane.

1) 10 mg of CNTs-PAH powder was dispersed in 100 mL of deionized water and ultrasonically treated for 30 min to obtain dispersion A.

2) 30 mL of the dispersion A was taken and a CNTs-PAH membrane was obtained by vacuum filtration.

### Comparative Example 3

Comparative Example 3 of the present disclosure provides a method of preparing an MXene membrane.

1) 10 mg of MXene powder was dispersed in 100 mL of deionized water and ultrasonically treated for 1 h to obtain dispersion A.

2) 30 mL of dispersion A was taken and a MXene membrane was obtained by vacuum filtration.

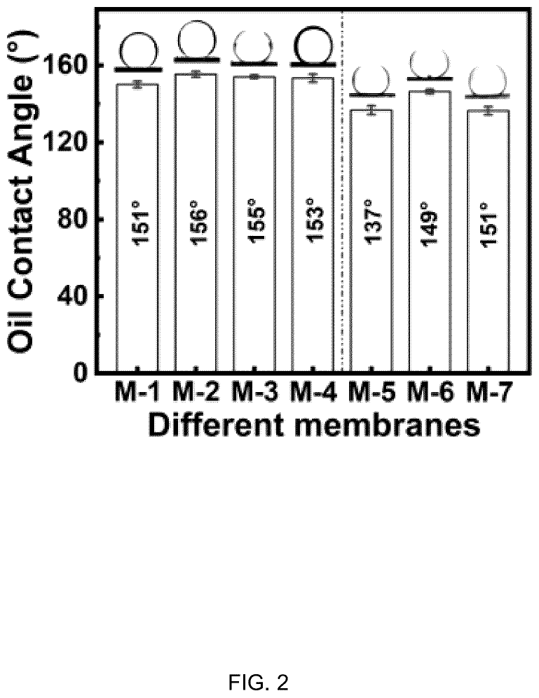

FIG. 2 is a block diagram illustrating contact angles of seven membranes against trichloromethane (chloroform) according to some embodiments of the present disclosure (M1: CNTs-PAH/Mxene-10 membrane, M2: CNTs-PAH/Mxene-20 membrane, M3: CNTs-PAH/Mxene-30 membrane, M4: CNTs-PAH/Mxene-50 membrane, M5: CNTs membrane, M6: CNTs-PAH membrane, M7: Mxene membrane). The underwater oil contact angles of the membranes in Example 1 are all greater than 150°, exhibiting underwater superoleophobic behavior. With the introduction of MXene, the oil contact angles of the membranes show a trend of increasing and then decreasing. This is due to the synergistic effect of the surface roughness and hydrophilicity of the composite membranes, which further improves the underwater superoleophobic behavior of the membranes. Among M-1, M-2, M-3, M-4, M5, M6 and M7, M-2 in Example 1 has higher rejection effect to chloroform, with underwater oil contact angles up to 156°. The oil contact angle of the CNTs membrane (M-5) in Comparative Example 1 is only 137°; after hydrazide functionalization, the oil contact angle of the CNTs-PAH membrane (M6) in Comparative Example 2 is increased to 149°; the MXene membrane (M-7) in Comparative Example 3 has an oil contact angle of 151° due to its rough surface structure.

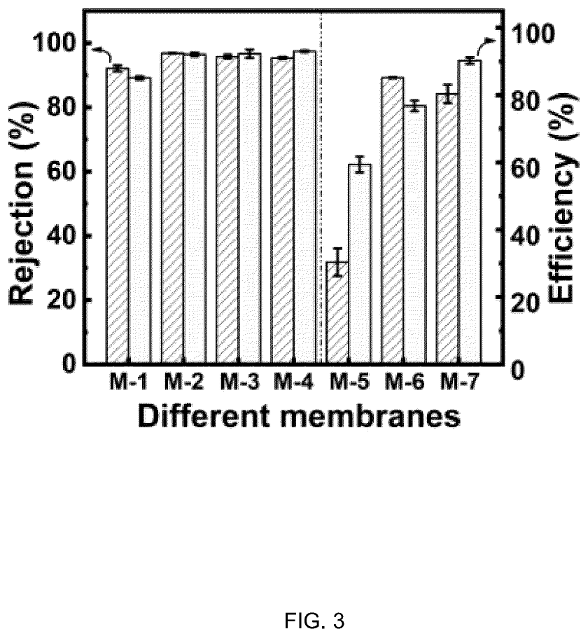

FIG. 3 is a block diagram illustrating an efficiency of recovering silver ions and an efficiency of oil-water separation of seven membranes in oil-water emulsions according to some embodiments of the present disclosure. As can be seen from Comparative Example 1, a recovery efficiency of Ag⁺ in the oil-water emulsion and a separation efficiency of the oil-water emulsion of the original carbon nanotube membrane (M-5) are very low, which are 31.8% and 59.4%, respectively; after modification, a recovery efficiency of Ag⁺ of CNTs-PAH membrane (M6) has been greatly improved (89.2%), but an oil-water separation efficiency is still not high (76.8%); in Comparative Example 3, the MXene membrane (M-7) has a recovery efficiency of Ag⁺ up to 84.2% and an oil-water separation efficiency is 92.6% due to its abundant unsaturated Ti atomic sites. The introduction of an appropriate amount of MXene into the composite membrane system can, to a certain extent, optimize the surface energy of the composite membrane to make it have the best separation performance for the oil-water emulsion, and it can also maximize the grabbing ability of the composite membrane for silver ions. With the increase of MXene content, the Ag⁺ recovery efficiency of the composite membrane shows a trend of increasing and then decreasing, and the oil-water separation efficiency is continuously improving. Among them, the CNTs-PAH/MXene-20 (M-2) membrane in Example 1 recovered precious metal ions in oil-water emulsions with a high efficiency of 96.9% and an oil-water separation efficiency of 92.1%.

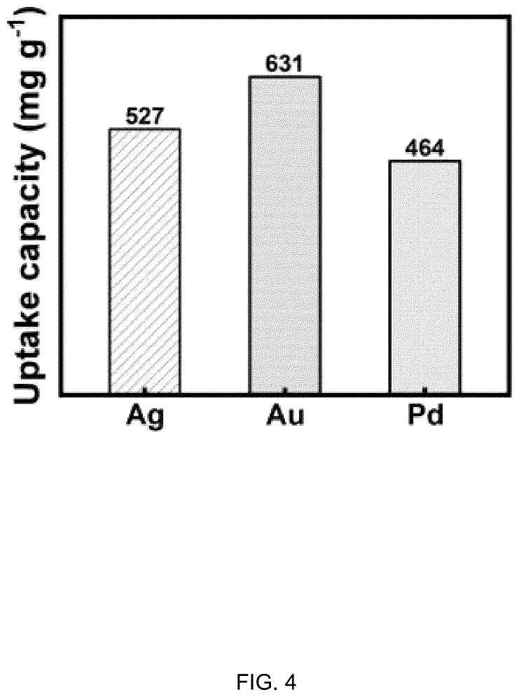

FIG. 4 is a block diagram illustrating maximum recovery capacities of CNTs-PAH/Mxene-20 membranes for three precious metal ions according to some embodiments of the present disclosure. The maximum recoveries of the CNTs-PAH/MXene-20 composite membrane for three precious metal ions Ag, Au and Pd are 527 mg/g, 631 mg/g and 464 mg/g, respectively.

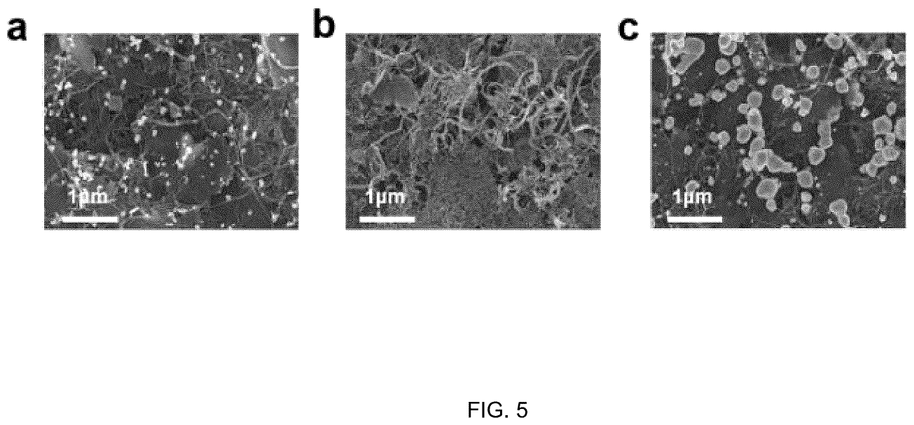

FIG. 5 is a scanning electron microscope (SEM) photograph of a CNTs-PAH/Mxene-20 membrane after recovery of Ag (a), Au (b), and Pd (c) according to some embodiments of the present disclosure, from which a large number of nanoparticles on the surface of the composite membrane can be clearly seen.

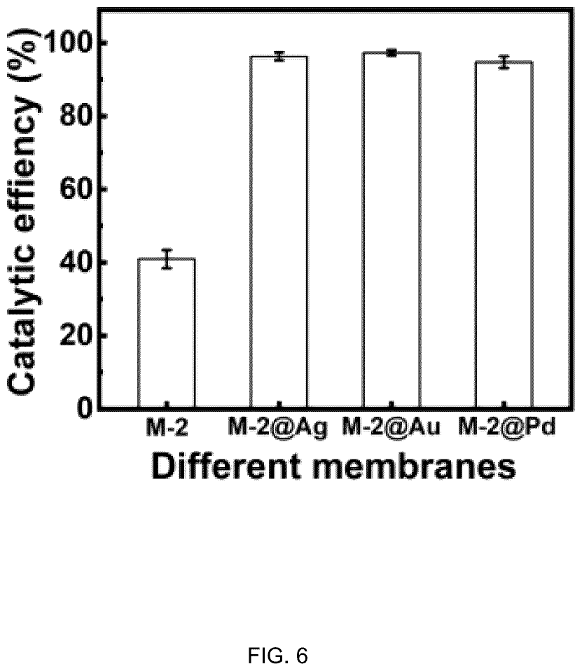

FIG. 6 is a block diagram illustrating catalytic efficiencies of CNTs-PAH/Mxene-20 (M-2) membranes for 4-nitrophenol (4-NP) after recovery of three precious metals according to some embodiments of the present disclosure. The catalytic efficiency of CNTs-PAH/Mxene-20 membrane (M-2) without precious metal loading is only 41.3%. The CNTs-PAH/Mxene-20 membranes (M-2) loaded with precious metal nanoparticles (M-2@Ag, M-2@Au, M-2@Pd) have excellent catalytic ability and can convert toxic p-nitrophenol to non-toxic p-aminophenol with catalytic efficiencies of 98.2%, 99.2%, and 96.6%, respectively.

The test/calculation methodology for the various indicators mentioned above is based on the following steps.

Precious metal recovery efficiency: firstly, a certain amount of silver nitrate (chloroauric acid, palladium chloride) was dissolved in 200 mL of deionized ultrapure water, and 1 g of Tween 80 was added to the above solution and stirred vigorously. Subsequently, 8 mL of trichloromethane was added and stirred vigorously for 4 hours to form an oil-in-water emulsion containing precious metal ions. The recovery efficiency of the membrane was tested using a vacuum filtration device at room temperature, and the effective filtration area of the membrane was 12.56 cm². The vacuum pressure was 1.0 bar, the concentrations of precious metal ions were all 20 ppm, and the filtration volume was 20 mL.

The precious metal recovery efficiency (R₁) was calculated by the following equation (1):

$${R}_{1} = ( 1 - \frac{{c}_{1}}{{c}_{0}} ) \times 100 \% \qquad ( 1 )$$

where C₁ is a concentration of precious metal ions in the filtrate and C₀ is a concentration of precious metal ions in the stock solution. The concentration of precious metal ions is obtained by AAS or ICPOES/MS testing.

The oil-water separation efficiency (R₂) was calculated by the following equation (2):

$${R}_{2} = ( 1 - \frac{{c}_{p}}{{c}_{f}} ) \times 100 \% \qquad ( 2 )$$

where Cₚ is an oil content in the filtrate and C_{f} is an oil content in the oil-in-water emulsion. Oil concentrations are obtained by UV-visible spectrophotometer tests.

Catalytic efficiency for 4-NP: 2.70 mL of aqueous 4-NP solution (0.10 mM) was mixed with 0.30 mL of NaBH₄ solution (0.10 mM). A catalytic ability of the membrane for 4-NP after recovery of precious metals was subsequently tested by vacuum filtration device.

The catalytic efficiency (R₃) was calculated by the following equation (3):

$${R}_{3} = ( 1 - \frac{{c}^{′}}{c} ) \times 100 \% \qquad ( 3 )$$

where C′ is a concentration of 4-NP in the filtrate and C is a concentration of 4-NP in the stock solution. The concentration of 4-NP is obtained by UV-visible spectrophotometer test.

The basic concepts have been described above, apparently, in detail, as will be described above, and do not constitute limitations of the disclosure. Although there is no clear explanation here, those skilled in the art may make various modifications, improvements, and modifications of the present disclosure. This type of modification, improvement, and corrections are recommended in the present disclosure, so the modification, improvement, and the amendment remain in the spirit and scope of the exemplary embodiment of the present disclosure.

At the same time, the present disclosure uses specific words to describe the embodiments of the present disclosure. As “one embodiment,” “an embodiment,” and/or “some embodiments” means a certain feature, structure, or characteristic of at least one embodiment of the present disclosure. Therefore, it is emphasized and should be appreciated that two or more references to “an embodiment” or “one embodiment” or “an alternative embodiment” in various parts of the present disclosure are not necessarily all referring to the same embodiment. Further, certain features, structures, or features of one or more embodiments of the present disclosure may be combined.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various embodiments. However, this disclosure does not mean that the present disclosure object requires more features than the features mentioned in the claims. Rather, claimed subject matter may lie in less than all features of a single foregoing disclosed embodiment.

With respect to each patent, patent application, patent application disclosure, and other material cited in the present disclosure, such as articles, books, manuals, publications, documents, etc., the entire contents thereof are hereby incorporated by reference into the present disclosure. Application history documents that are inconsistent with the contents of the present disclosure or that create conflicts are excluded, as are documents (currently or hereafter appended to the present disclosure) that limit the broadest scope of the claims of the present disclosure. It should be noted that in the event of any inconsistency or conflict between the descriptions, definitions, and/or use of terms in the materials appended to the present disclosure and those described in the present disclosure, the descriptions, definitions, and/or use of terms in the present disclosure shall prevail.

At last, it should be understood that the embodiments described in the present disclosure are merely illustrative of the principles of the embodiments of the present disclosure. Other modifications that may be employed may be within the scope of the present disclosure. Thus, by way of example, but not of limitation, alternative configurations of the embodiments of the present disclosure may be utilized in accordance with the teachings herein. Accordingly, embodiments of the present disclosure are not limited to that precisely as shown and described.

What is claimed is:

1. A method for preparing a functional membrane for recovering precious metal ions from oily wastewater, comprising:
(a) obtaining carbon nanotubes functionalized by polyacrylic acid (CNTs-PAA) by grafting acrylic acid onto a surface of carbon nanotubes (CNTs) via graft polymerization;
(b) obtaining carbon nanotubes modified by acyl hydrazine functional groups (CNTs-PAH) by reacting adipic dihydrazide (ADH) with carboxyl functional groups of the CNTs-PAA;
(c) preparing single-layer MXene nanosheets using Ti₃AlC₂ powder; and
(d) preparing a CNTs-PAH/MXene composite membrane by vacuum filtration based on the CNTs-PAH and the single-layer Mxene nanosheets.

2. The method of claim 1, wherein the obtaining the CNTs-PAA includes:
dispersing the CNTs in acetone and performing ultrasonic treatment to obtain a CNTs dispersion;
adding acrylic acid after vacuum distillation and recrystallized benzoyl peroxide (BPO) to the CNTs dispersion to obtain a mixture; and
obtaining the CNTs-PAA by washing the mixture with deionized water and vacuum dry at 30° C.

3. The method of claim 1, wherein the step (b) includes: dispersing the CNTs-PAA in N,N-dimethylformamide (DMF), adding N,N′-carbonyldiimidazole (CDI) to obtain a mixed solution; adding the mixed solution to a DMF solution containing adipic dihydrazide to obtain a mixture; and obtaining the CNTs-PAH by subjecting the mixture to filtration and vacuum dry at 30° C.

4. The method of claim 1, wherein the step (c) includes: adding lithium fluoride to hydrochloric acid to prepare an etching solution; adding the Ti₃AlC₂ powder to the etching solution under an ice-water bath condition, transferring to an oil bath for stirring to obtain a product; centrifugally washing the product with deionized water, removing a precipitate by high-speed centrifugation to obtain a suspension, freeze-drying the suspension to obtain the MXene (Ti₃C₂TxMXene) nanosheets.

5. The method of claim 1, wherein the step (d) includes: dispersing the CNTs-PAH in deionized water and performing ultrasonic treatment to obtain a CNTs-PAH dispersion; dispersing the MXene nanosheets in deionized water and performing ultrasonic treatment to obtain a MXene dispersion; and mixing the MXene dispersion and the CNTs-PAH dispersion to obtain a mixture, and filtering the mixture into a membrane after ultrasonic treatment.

6. The method of claim 5, wherein a mass ratio of the CNTs-PAH to the MXene nanosheets is 1:(0.1-0.5).

7. A functional membrane for recovering precious metal ions from oily wastewater, which is prepared by the method of claim 1.
